(19) United States
(12) Patent Application Publication
(10) Pub. No.: US 2002/0112349 A1
(43) Pub. Date: Aug. 22, 2002

(54) Means for securing screws for assembled pistons

(75) Inventor: Roland Lochmann, Marbach (DE)

Correspondence Address: WILLIAM COLLARD, COLLARD & ROE, P.C., 1077 NORTHERN BOULEVARD, ROSLYN, NY, 11576, US

(73) Assignee: MAHLE GmbH

(21) Appl. No.: 10/074,292

(22) Filed: Feb. 12, 2002

(30) Foreign Application Priority Data
Feb. 16, 2001 (DE) 101 07 425.5

(51) Int. Cl. B23P 15/10

(52) U.S. Cl. 29/888.044

(57) ABSTRACT

A way to securing screws in assembled pistons, in which the piston crown is joined with a bottom part of the piston by means of tension screws. The screws are secured via an adhesive comprising a mixture of a two-component resin and a solid lubricant or lubricating paste applied to the screw threads or to the contact surface of the screw thread.

### BACKGROUND OF THE INVENTION

1. Field of the Invention

The invention relates to a means for securing screws for assembled pistons in which a piston crown is joined with a piston bottom part by means of tension screws.

2. The Prior Art

Lack of means to keep screws from turning loose may pose a problem especially in connection with small assembled pistons. The loosening torque frequently amounts to only about 30% of the tightening torque. Known mechanical means for securing the screws frequently result in lower initial screw tensioning forces; they are more costly to produce and can be mounted only with difficulty, particularly in small pistons.

### SUMMARY OF THE INVENTION

It is therefore an object of the invention to provide means for securing the screws that will lead to a distinct increase of the loosening torque and can be produced in a simple manner.

This object is accomplished by a securing means for screws for constructed pistons, in which the piston crown is joined with a bottom part of the piston by means of expanding screws, comprising an adhesive comprising a mixture of a two-component resin and a solid lubricant or lubricating paste. The adhesive, which consists of a mixture of solid lubricant and two-component resin, is preferably thoroughly mixed before it is applied to the surface areas to be glued together.

MoS₂ in the form of paste can be added during the preparation of the adhesive. The lubricant component provides for low and constant friction values during the installation. Following curing, the loosening torque is at the level of the tightening torque and to some extent even above the latter.

The adhesive mixture can be applied either to the thread or to the surface of contact of the screw head.

The adhesive compound that is squeezed out of the area of contact as the screws are being tightened, forms on the screw head or on the nut a concave fillet extending all around with an approximately triangular cross section.

Since the fillet is not attacked when the motor is operating, it represents a relatively safe design in recognition of an original installation.

### BRIEF DESCRIPTION OF THE DRAWINGS

Other objects and features of the present invention will become apparent from the following detailed description considered in connection with the accompanying drawing. It is to be understood, however, that the drawing is designed as an illustration only and not as a definition of the limits of the invention.

FIG. 1 shows a cross sectional view of an assembled piston held together by tension screws.

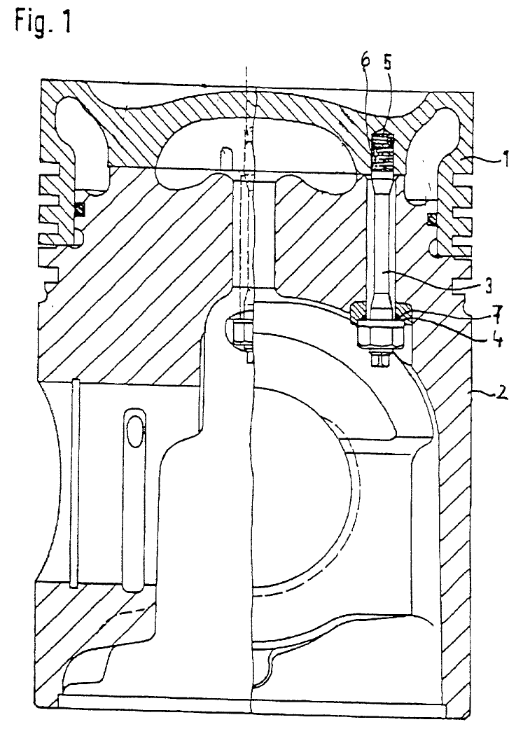

### DETAILED DESCRIPTION OF THE PREFERRED EMBODIMENT

Referring now in detail to the drawing, there is shown a cross section of a piston crown 1 and piston bottom 2 secured together by tension screws 3.

An adhesive mixture 6 is applied either to the thread 5 or to the surface of contact 4 of the screw head.

The adhesive compound 6 that is squeezed out of the area of contact as the screws 3 are being tightened, forms on the screw head 4 or on the nut a concave fillet 7 extending all around with an approximately triangular cross section.

Since fillet 7 is not attacked when the motor is operating, it represents a relatively safe sign in recognition of an original installation.

In this manner, a screw 3 for assembled pistons in which a piston crown 1 is connected with a piston bottom part 2 by means of tension screws 3 is rapidly and simply held in position.

Accordingly, while only a single embodiment of the present invention have been shown and described, it is obvious that many changes and modifications may be made thereunto without departing from the spirit and scope of the invention.

What is claimed is:

1. A means for securing screws in assembled pistons, in which the piston crown is joined with a bottom part of the piston by means of tension screws, comprising an adhesive comprising a mixture of a two-component resin and a solid lubricant or lubricating paste.

2. The means for securing screws according to claim 1, wherein the solid lubricant is MOS₂ or graphite powder or a mixture thereof.

3. The means for securing screws according to claim 1, wherein boron nitride is present as the solid lubricant.

4. A method for securing screws in assembled pistons, in which the piston crown is joined with a bottom part of the piston by means of tension screws, comprising applying an adhesive comprising a mixture of a two-component resin and a solid lubricant or lubricating paste to a portion of the screw.

5. The method for securing screws according to claim 4, wherein the adhesive is applied to a thread of the screw.

6. The method for securing screws according to claim 4, wherein the adhesive is applied to a contact surface of a screw head or a nut.

7. The means fore securing screws according to claim 6, wherein following tightening of the screwed joint, excess adhesive forms radially outside of the contact surface of the screw head or nut a ring extending all around with the cross section of a concave fillet or a triangle.

8. The method for securing screws according to claim 6, wherein the contact surface of the screw head is hexagonal.

9. The method for securing screws according to claim 6, wherein the contact surface of the screw head or nut is profiled.

10. The method for securing screws according to claim 4, wherein the solid lubricant is MoS₂ or graphite powder or a mixture thereof.

11. The method for securing screws according to claim 4, wherein boron nitride is present as the solid lubricant.
